(19) United States
(12) Patent Application Publication
(10) Pub. No.: US 2011/0275256 A1
(43) Pub. Date: Nov. 10, 2011

(54) IMPROVEMENTS IN OR RELATING TO AMPHIBIANS

(75) Inventors: Alan Timothy Gibbs, London (GB); Anthony Roy Mudd, Warwickshire (GB); James Neville Randle, Welford On Avon (GB)

(73) Assignee: GIBBS TECHNOLOGIES LTD, Warwickshire (GB)

(21) Appl. No.: 12/999,997

(22) PCT Filed: Jun. 19, 2009
(86) PCT No.: PCT/GB09/01559

§ 371 Date: Jul. 26, 2011

(30) Foreign Application Priority Data
Jun. 19, 2008 (GB) GB 0811335.9

(51) Int. Cl. B60F 3/00; B62K 5/02

(52) U.S. Cl. 440/12.51

(57) ABSTRACT

A three- or four-wheeled amphibian (1) comprises hull (2), body (3), front steered wheel (11) or wheels (11, 11′), and rear wheel (9) or wheels (9, 9′). Each steered wheel is connected to the amphibian by a retractable suspension assembly (10, 10′). Upper and lower suspension arms (14 and 15) have pivotal connections (17) and (18) to inner upright arm (16). Retraction rams (28) are connected to body (3), and can retract the wheels for use on water and protract them for use on land. Wheels (11, 11′) also lean on cornering. The pivotal connections (17, 18) for wheel retraction are also used to facilitate leaning. This may be allowed through rotation of drop link (31) around pivot (32). A motor and gearbox assembly (30) may be attached to body (3) to provide controlled lean when cornering, and to keep the amphibian (1) upright when stationary. Leaning may be powered, or user-initiated. Powered lean correction may be provided.

The present invention relates to a three- or four-wheeled amphibian having retractable wheel and suspension assemblies and, in particular, to a three- or four-wheeled amphibian which is capable of leaning when cornering. The present invention also relates to a retractable wheel and suspension assembly for use in a three- or four wheeled amphibian according to the present invention.

Leaning three-wheeled vehicles are known in the art and an example is provided in EP 1155950 (Piaggio). This example has two front steered wheels and one rear wheel. The two front wheels are linked by a suspension assembly that allows an inside wheel to move to a position relatively higher than the inside wheel when not cornering, and the outside wheel to move to a relatively lower location, so that both front wheels remain on the ground when cornering.

Three- and four-wheeled amphibians are known in the art and examples are disclosed in the applicant's International patent applications published under serial nos. WO 2008/023191 and WO 2006/043088. However, these amphibians are not designed to lean on land.

The aim of the present invention is to improve handling and ease of use of a three- or four-wheeled amphibian on land. Because bicycles and motorcycles lean into corners—that is, roll inwardly towards the apex of the corner—a rider may instinctively expect any amphibian steered by handlebars to lean inwards on corners. Conversely, an amphibian with handlebars which rolls or leans outwards on corners may unsettle the rider. The rider may therefore not enjoy riding the amphibian and may also lack confidence in the amphibian. Confidence and enjoyment may be enhanced by providing a more predictable and instinctively “right” riding experience.

According to a first aspect, the present invention provides a three- or four-wheeled amphibian for use on land and water comprising one or two front steered wheels, one or two rear wheels, and a hull section, each steered wheel being connected to the amphibian by a retractable suspension assembly comprising one or more suspension arms, one or more pivotal connections for the one or more suspension arms, and retraction means connected to the one or more suspension arms which, in use, acts upon the one or more suspension arms to provide movement between a protracted land-use position and a retracted water-use position of each steered wheel, wherein the retraction means is movably-connected to the amphibian to accommodate an alteration of orientation of the one or more suspension arms of the steered wheel with respect to the ground upon which it stands when steering the steered wheel and/or leaning the amphibian, such that movement of the one or more suspension arms for retraction and protraction, and for altering orientation is accommodated through the same pivotal connection of the one or more pivotal connections.

Advantageously, the present invention provides a leaning amphibian with a retractable suspension assembly which addresses the problem of how to combine a leaning suspension for use on land, with a retractable suspension which allows the amphibian to plane on water by retracting the wheels above the water line.

Where the amphibian is a planing amphibian, particularly with a vee-type hull, the amphibian will lean inwards when turning on water, as a jetski does. It is advantageous to the rider if the amphibian behaves consistently on land and on water.

A further problem found with most, if not all, amphibians is that they tend to be heavy because different components are used on land and on water, and some duplication of systems and components can occur. Conversely, any systems and components which have dual uses will help to reduce cost, weight, fuel consumption, and exhaust emissions, and through these savings, will enhance performance and handling of the amphibian, and riding pleasure for a user.

Preferably, the retraction means is pivotally-connected to the amphibian. Further preferably, the retraction means comprises a drop link pivotally-connected to the body and separately, pivotally-connected to the retraction means. The retraction means may comprise a centrally mounted drop link which is pivotally-connected to the body, and which is pivotally-connected to two retraction means, one being on each side of the drop link for a separate suspension assembly.

Preferably, the retraction means allows passive lean or user-initiated lean of said amphibian when cornering against a resistance provided by the retraction means. The retraction means may provide correction of passive or user-initiated lean through a counter force initiated by the passive or user-initiated lean. Alternatively, the retraction means may provide powered correction of passive or user-initiated lean. Preferably, the retraction means provides powered lean of said amphibian when cornering, and may provide powered correction of lean when cornering.

Preferably, the three- or four-wheeled amphibian comprises a damper operatively-connected to the upper and lower suspension arms, wherein the damper allows passive lean or user-initiated lean of said amphibian when cornering against a resistance provided by the damper. The damper may provide correction of passive or user-initiated lean through a counter force initiated by the passive or user-initiated lean. Preferably, the three- or four-wheeled amphibian comprises leaning means which provides powered correction of passive or user-initiated lean. Preferably, the three- or four-wheeled amphibian comprises leaning means which provides powered lean of said amphibian when cornering, and may provide powered correction of lean when cornering.

Preferably, the three- or four-wheeled amphibian comprises one or more sensors for detecting velocity and/or degree of turning in order to provide a correct amount of lean, and/or yaw rate to detect skids.

Most preferably, the three- or four-wheeled amphibian comprises locking means to prevent uncontrolled and/or undesirable lean of said amphibian, which acts on the suspension assembly.

The retraction-means may comprise an electrical, pneumatic or hydraulic arrangement. A single retraction means may operate the suspension assembly of both sides of said amphibian or, alternatively, a retraction means may be provided for each suspension assembly.

The one or more suspension arms, preferably, comprise two suspension arms, one upper and one lower, which contact a suspension upright at respective upper and lower locations and which suspension upright receives the wheel. The lower suspension arm may be pivotally-connected to a body of the amphibian, either directly or through other linkages.

Preferably, the retraction means is pivotally-connected to a/the body of the amphibian, either directly or through other linkages. Preferably, the retraction means is pivotally-connected to the upper suspension arm and an upright arm. Preferably, the upper and lower suspension arms are pivotally-connected to an/the upright arm, which maintains the separation distance of the arms.

The three- or four-wheeled amphibian may comprise one or more steering arms to allow the suspension assembly to be steered in use. Additionally, or alternatively, the three- or four-wheeled amphibian comprises drive means to provide drive to the front and/or rear wheels.

Preferably, the three- or four-wheeled amphibian comprises left- and right-hand steered wheels which are operably-connected so as to move together through turning and through altering orientation thereof. The left- and right-hand steered wheels may be further pivotally-mounted to the body of the amphibian through a common linkage to further accommodate for leaning of the amphibian. Alternatively, the left- and right-hand steered wheels may be further pivotally-mounted to the body of the amphibian through separate linkages to further accommodate for leaning of the amphibian.

Preferably, the rear wheel is retractable.

Preferably, the three- or four-wheeled amphibian comprises a Vee-type hull.

A three- or four-wheeled amphibian may comprise one or more leaning suspension assemblies and a Vee-type hull.

According to a second aspect of the present invention, there is provided a suspension assembly for an amphibian comprising:
one or more suspension arms comprising a wheel hub mount for receiving a wheel, which arms is/are capable of connecting with said amphibian;
one or more pivotal connections for the one or more suspension arms; and

retraction means connected to the one or more suspension arms and movably-connectable with said amphibian for, in use, moving the one or more suspension arms around the one or more pivotal connections with respect to said amphibian between a protracted land-use position and a retracted water-use position, wherein, in the protracted land-use position, the one or more suspension arms are further moveable around the one or more pivotal connections to alter orientation of the wheel hub mount with respect to the ground when steering and/or leaning of said amphibian, such that movement of the one or more suspension arms for retraction and protraction, and for altering orientation is accommodated through the same pivotal connection of the one or more pivotal connections.

The retraction means may allow passive lean or user-initiated lean of said amphibian when cornering against a resistance provided by the retraction means. The retraction means may provide correction of passive or user-initiated lean through a counter force initiated by the passive or user-initiated lean. The retraction means may provide powered correction of passive or user-initiated lean. Alternatively, the retraction means provides powered lean of said amphibian when cornering. Further, the retraction means may provide powered correction of lean when cornering.

Preferably, the suspension assembly comprises a damper operatively-connected to the upper and lower suspension arms, wherein the damper allows passive lean or user-initiated lean of said amphibian when cornering against a resistance provided by the damper. The damper may provide correction of passive or user-initiated lean through a counter force initiated by the passive or user-initiated lean.

Preferably, the suspension assembly comprises leaning means which provides powered correction of passive or user-initiated lean. The leaning means may provide powered lean of said amphibian when cornering, and may provide powered correction of lean when cornering.

Preferably, the suspension assembly comprises one or more sensors for detecting velocity and/or degree of turning of said amphibian in order to provide a correct amount of lean, and/or yaw rate to detect skids.

Preferably, the suspension assembly comprises locking means to prevent uncontrolled and/or undesirable lean of said amphibian, especially at low speed.

The retraction means may comprise an electrical, pneumatic or hydraulic arrangement. A single retraction means may operate two suspension assemblies for both sides of said amphibian or a retraction-means may be provided for each suspension assembly.

The lower suspension arm may be pivotally-connectable to a body of an amphibian, either directly or through other linkages. The retraction means may be pivotally-connectable to a body of said amphibian, either directly or through other linkages. The one or more suspension arms may comprise two suspension arms, one upper and one lower, which contact a suspension upright at respective upper and lower locations. The upper and lower suspension arms may be pivotally-connected to the suspension upright. Further, the upper and lower suspension arms may be pivotally-connected to an upright arm, which maintains the separation distance of the arms. Preferably, the retraction means is pivotally-connected to the upper suspension arm and the upright arm.

Preferably, the suspension assembly comprises one or more steering arms to allow the suspension assembly to be steered in use.

Preferably, the suspension assembly comprises drive means to provide drive to the wheel hub.

Preferably, the retraction means is pivotally-connectable to the amphibian. The retraction means may comprise a drop link pivotally-connectable to the body and separately, pivotally-connected to the retraction means. Further, the retraction means may comprise a centrally mounted drop link which is pivotally-connectable to the body, and which is pivotally-connected to two retraction means, one being on each side of the drop link for a separate suspension assembly.

According to a further aspect, the present invention provides a three- or four-wheeled amphibian for use on land and water comprising two front steered wheels, one rear wheel and a hull section, each steered wheel being connected to the amphibian by a retractable suspension assembly comprising one or more suspension arms, one or more pivotal connections for the one or more suspension arms, and retraction means connected to the one or more suspension arms which, in use, acts upon the one or more suspension arms to provide movement between a protracted land-use position and a retracted water-use position of each steered wheel,

wherein the retraction means also acts, in use, upon the one or more suspension arms to alter orientation of the steered wheel with respect to the ground upon which it stands when steering the steered wheel and/or leaning the amphibian, such that movement of the one or more suspension arms for retraction and protraction, and for altering orientation is accommodated through the same pivotal connection of the one or more pivotal connections.

In a further aspect, the present invention provides an amphibian for use in land and marine modes comprising:

a planing hull;

three wheel stations, two of the three wheel stations being front wheel stations provided one on each side of and in the front half of the amphibian, and the third wheel station being a rear wheel station provided in the rear half of the amphibian;

at least one wheel provided at each wheel station, each wheel being movable between a protracted land mode position and a retracted marine mode position;

a retractable suspension assembly provided at each wheel station for supporting the at least one wheel, the front wheel station retract-able suspension assemblies each being configured to provide capability for leaning of the amphibian when in use in land mode;

land propulsion means to propel the amphibian on land in the land mode, the land propulsion means comprising at least one of the wheels; and

marine propulsion means to propel the amphibian on water in the marine mode.

In a further aspect, the present invention provides an amphibian for use in land and marine modes comprising:

a planing hull;

three wheel stations, two of the three wheel stations being rear wheel stations provided one on each side of and in the rear half of the amphibian, and the third wheel station being a front wheel station provided in the front half of the amphibian;

at least one wheel provided at each wheel station, each wheel being movable between a protracted land mode position and a retracted marine mode position;

a retractable suspension assembly provided at each wheel station for supporting the at least one wheel, the rear wheel station retractable suspension assemblies each being configured to provide capability for leaning of the amphibian when in use in land mode;

land propulsion means to propel the amphibian on land in the land mode, the land propulsion means comprising at least one of the wheels; and

marine propulsion means to propel the amphibian on water in the marine mode.

In a further aspect, the present invention provides an amphibian for use in land and marine modes comprising:

a planing hull;

four wheel stations, two of the four wheel stations being front wheel stations provided one on each side of and in the front half of the amphibian, and two of the four wheel stations being rear wheel station provided one on each side of and in the rear half of the amphibian in the front half of the amphibian;

at least one wheel provided at each wheel station, each wheel being movable between a protracted land mode position and a retracted marine mode position;

a retractable suspension assembly provided at each wheel station for supporting the at least one wheel, the wheel station retractable suspension assemblies each being configured to provide capability for leaning of the amphibian when in use in land mode;

land propulsion means to propel the amphibian on land in the land mode, the land propulsion means comprising at least one of the wheels; and

marine propulsion means to propel the amphibian on water in the marine mode.

In a further aspect, the present invention provides a method of providing leaning capability for an amphibian.

In the context of this application, passive lean and user-initiated lean are defined as being different to powered lean. In a powered system, sensors are required to detect steering amounts and/or speed of travel to determine the correct amount of lean to be applied to an amphibian when cornering. Of course, correction of the lean back to an upright condition may also be powered. Owing to the wheel arrangement, the amphibian will act in a manner very similar to a motorbike. Passive lean is a condition provided mainly by the weight of the amphibian and a tendency of the amphibian to lean more to one side than the other at rest or moving, depending upon the position of the steered wheels. When the steered wheels are straight, however, the amphibian should not lean to either side. But once the steering is turned, the weight of the amphibian will rest more on one side than the other, providing passive lean of the amphibian in the direction the steered wheels are turned. Further, a user can initiate lean by altering their position on the amphibian with respect to the seating position. Therefore, by placing one's weight more to one side, the amphibian will lean in the direction that the weight has been placed. Therefore, combining passive and user-initiated lean allows the amphibian to resemble a motorbike and to lean in to corners and turns.

Preferred embodiments of the present invention will now be described by way of example only with reference to the accompanying drawings, in which:

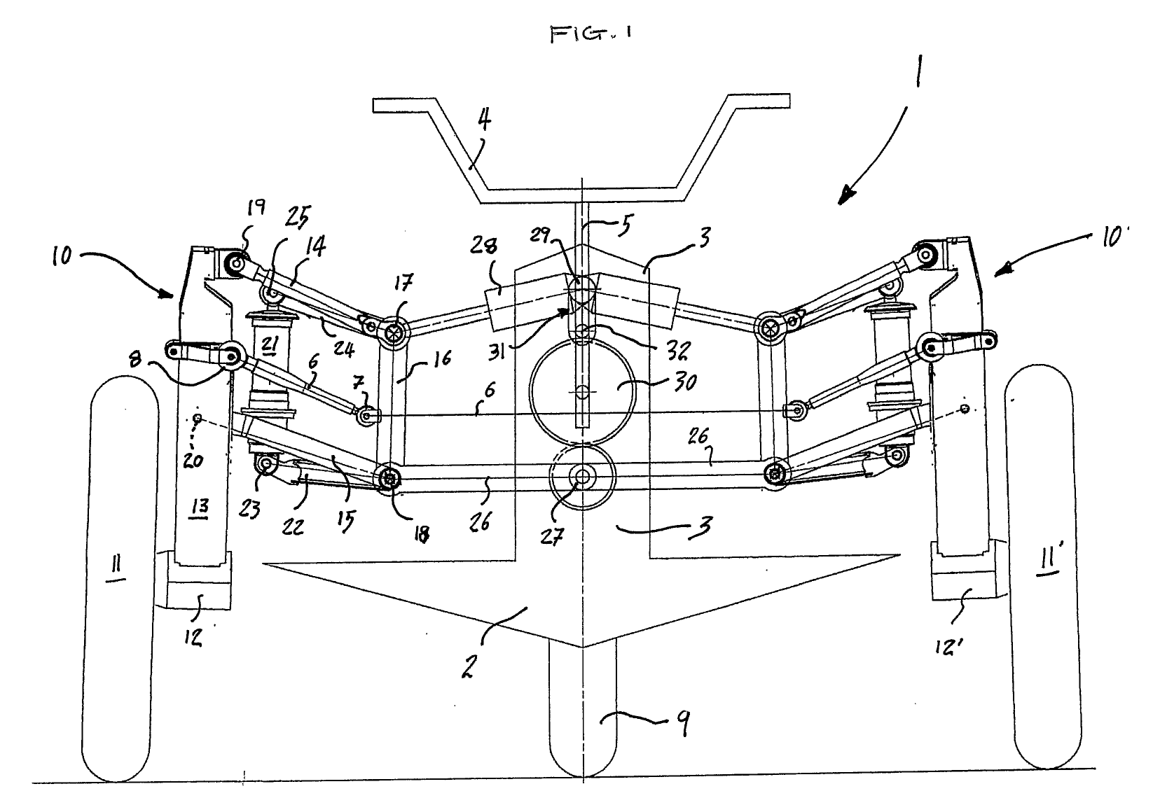

FIG. 1 is a schematic partial-front elevation view of a three-wheeled amphibian according to a first preferred embodiment of the present invention, shown in a land mode with wheel and suspension assemblies protracted;

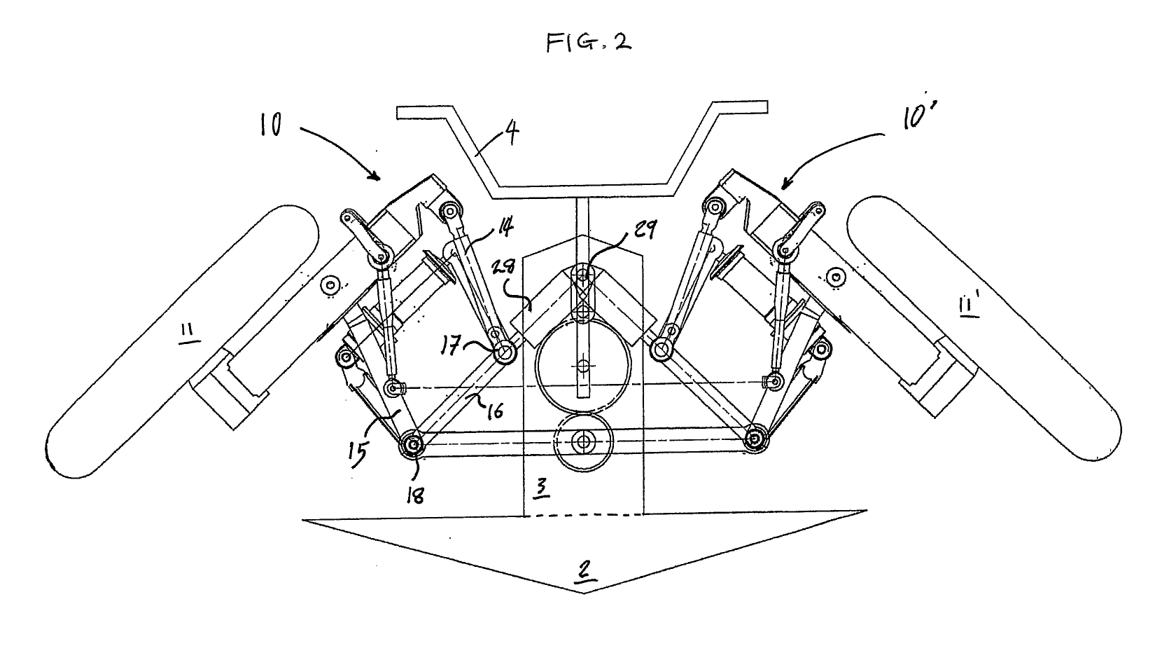

FIG. 2 is a schematic partial-front elevation view of the amphibian of FIG. 1, shown in a marine mode with wheel and suspension assemblies retracted;

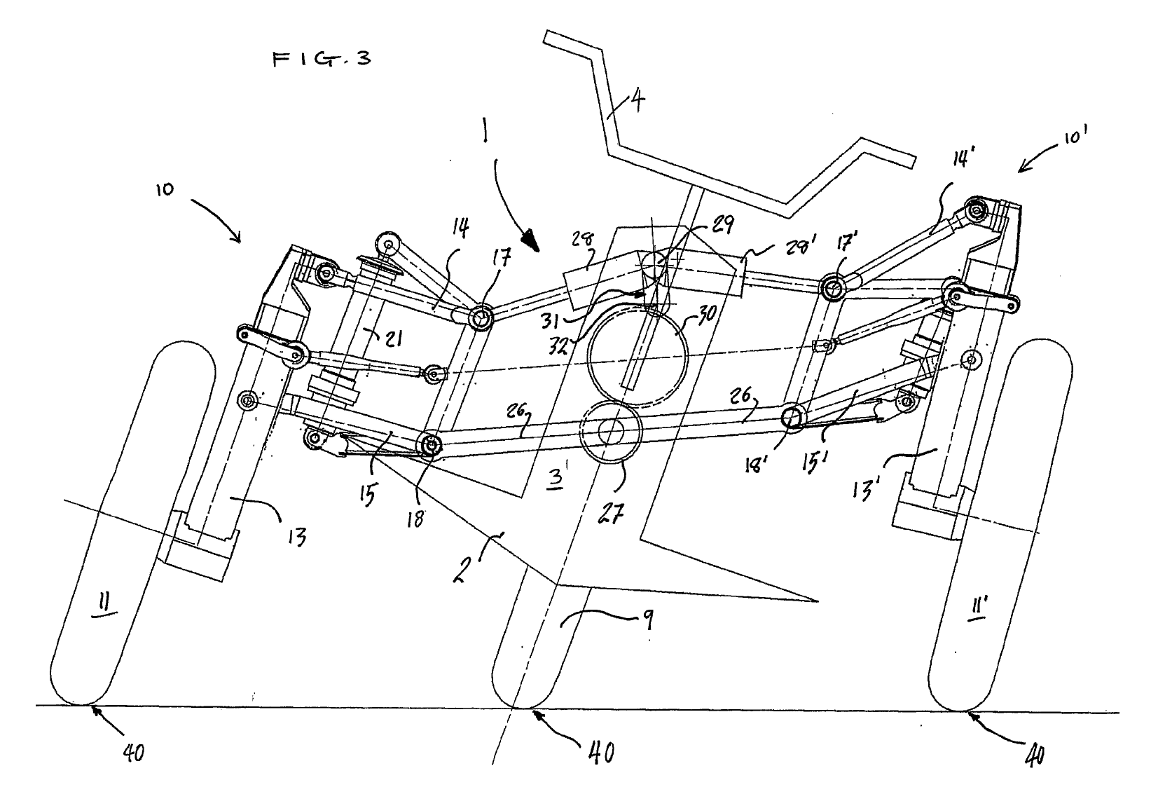

FIG. 3 is a schematic partial-front elevation view of the amphibian of FIG. 1, shown cornering or leaning on land in a land mode;

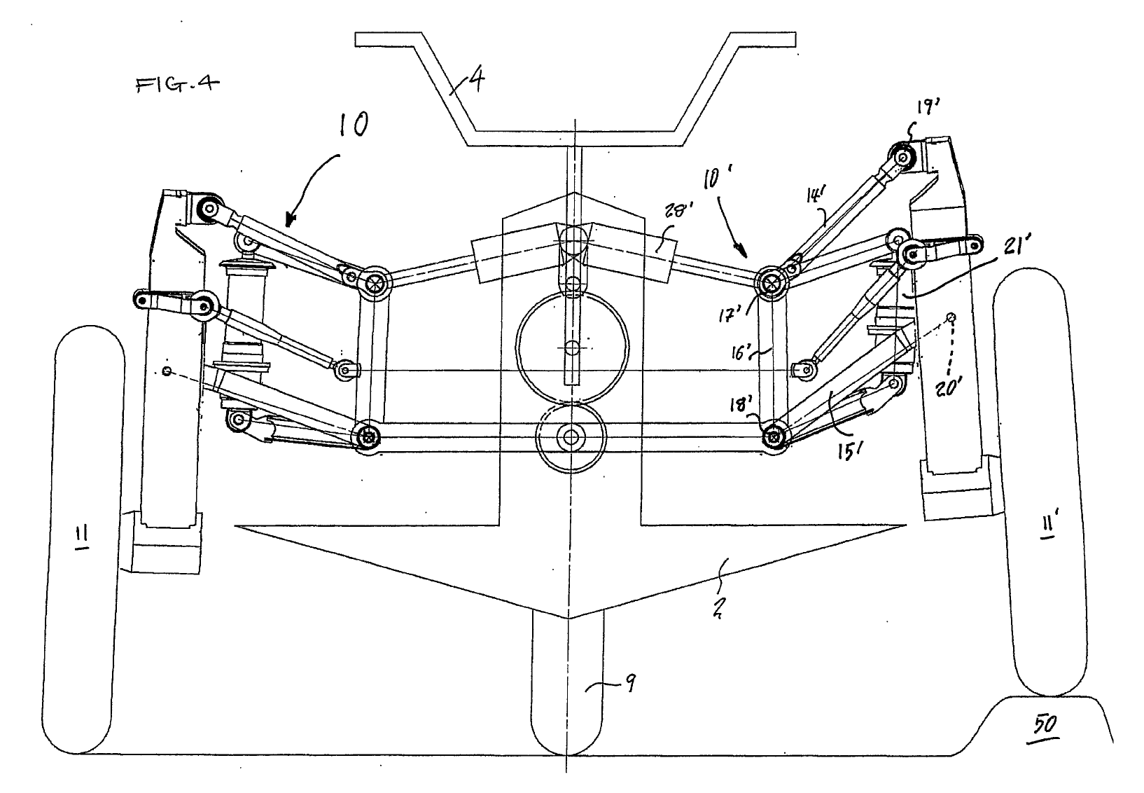

FIG. 4 is a schematic partial-front elevation view of the amphibian of FIG. 1, showing operation of a suspension assembly in bump travel in a land mode;

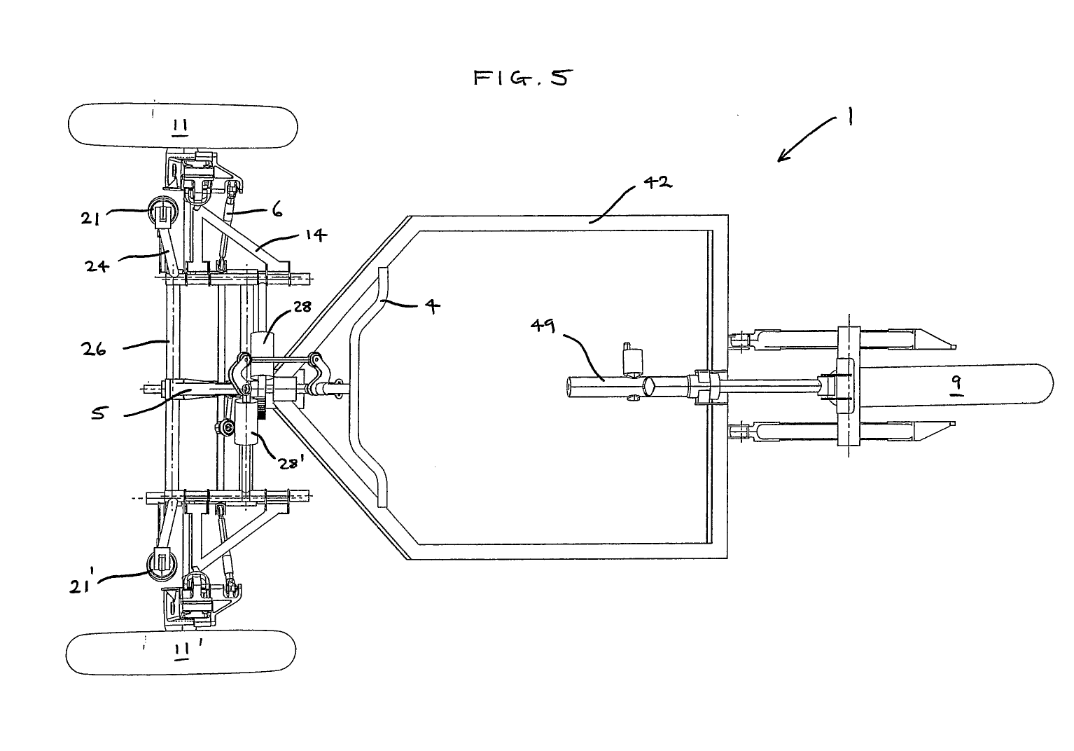

FIG. 5 is a schematic partial-plan view from above of the amphibian of FIG. 1, shown in a land mode with wheel and suspension assemblies protracted;

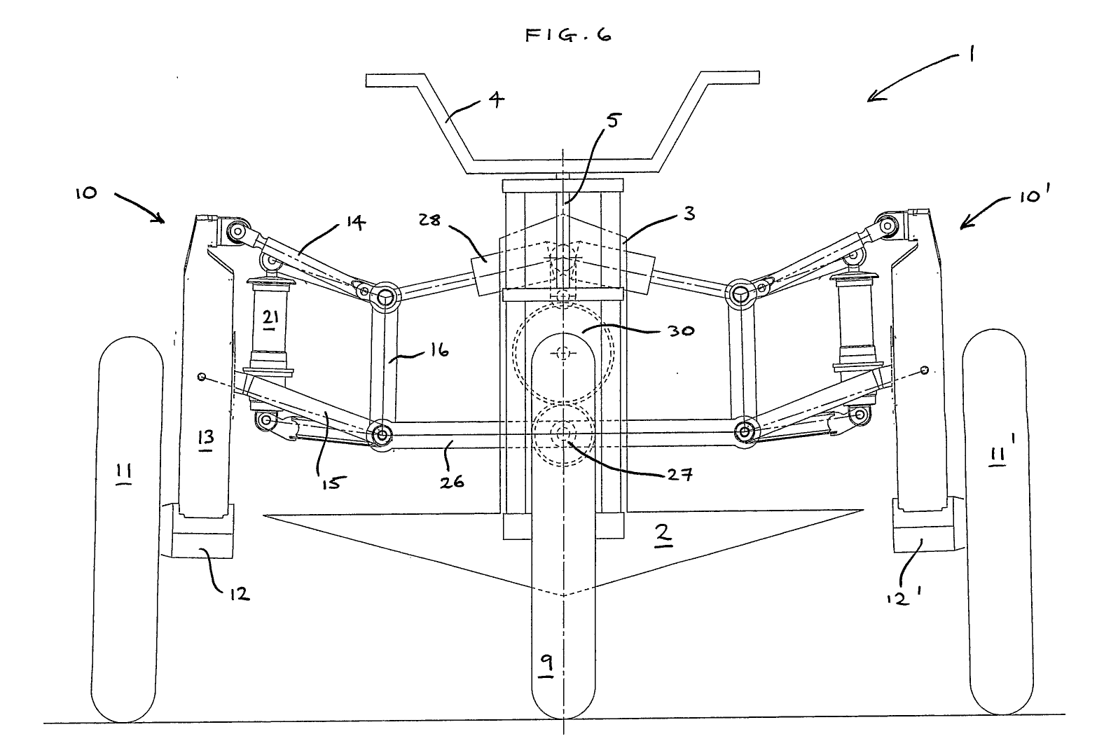

FIG. 6 is a schematic partial-front elevation view of a three-wheeled amphibian according to a second preferred embodiment of the present invention, shown in a land mode with wheel and suspension assemblies protracted;

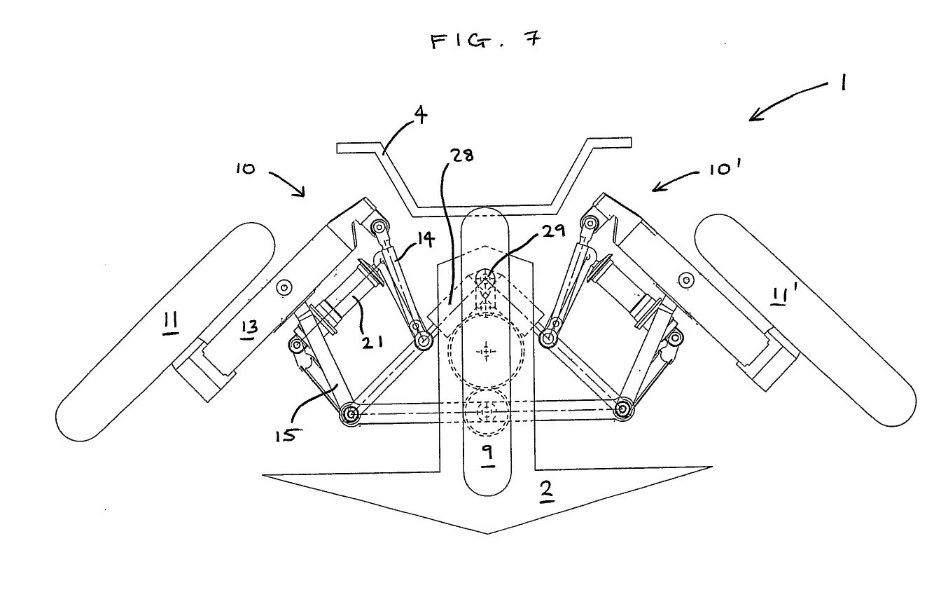

FIG. 7 is a schematic partial-front elevation view of the amphibian of FIG. 6, shown in a marine mode with wheel and suspension assemblies retracted;

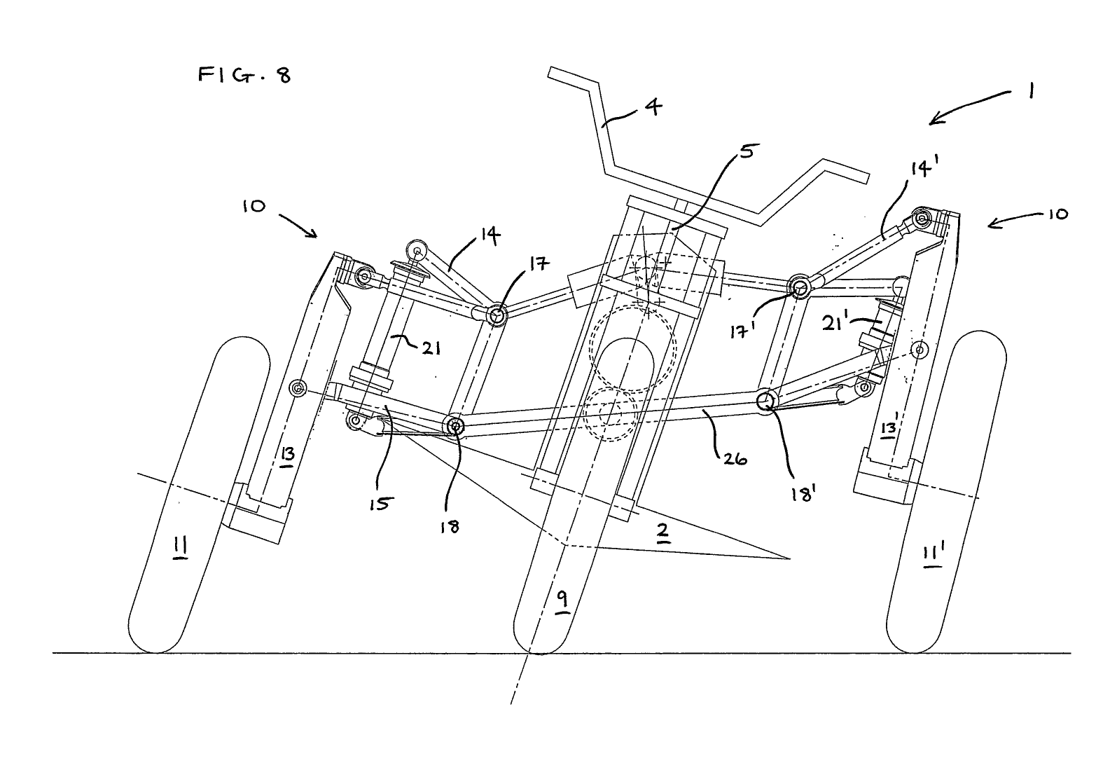

FIG. 8 is a schematic partial-front elevation view of the amphibian of FIG. 6, shown cornering or leaning on land in a land mode;

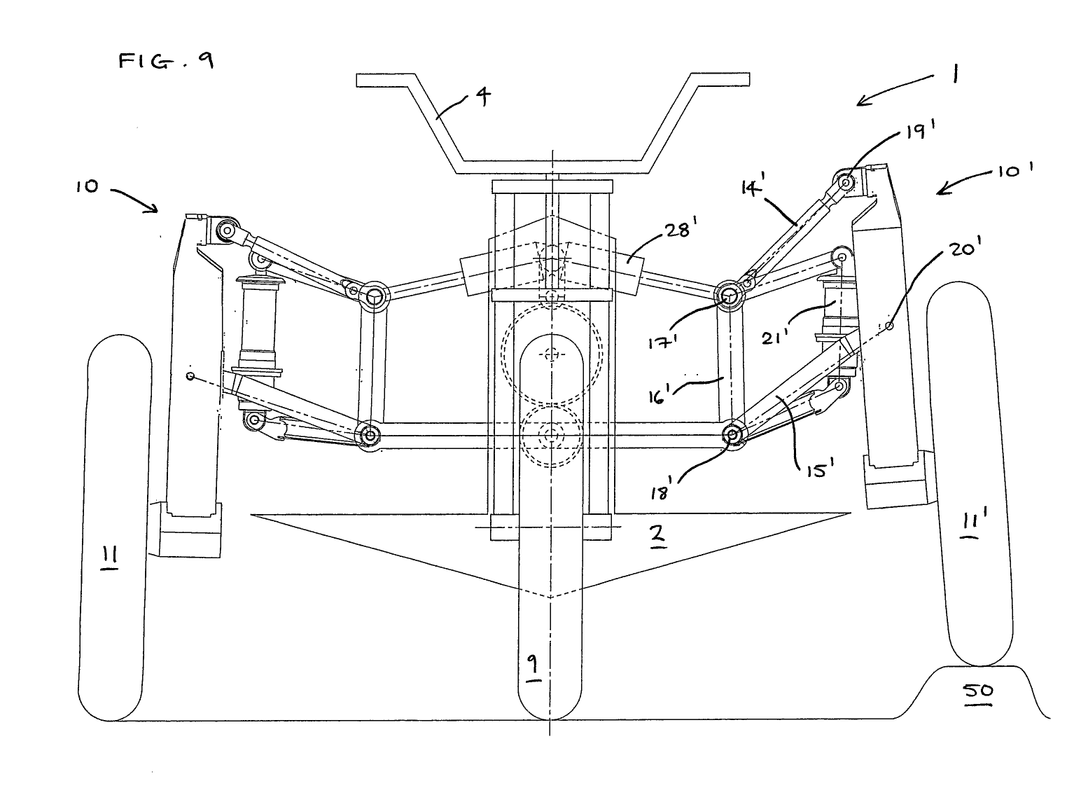

FIG. 9 is a schematic partial-front elevation view of the amphibian of FIG. 6, showing operation of a suspension assembly in bump travel in a land mode;

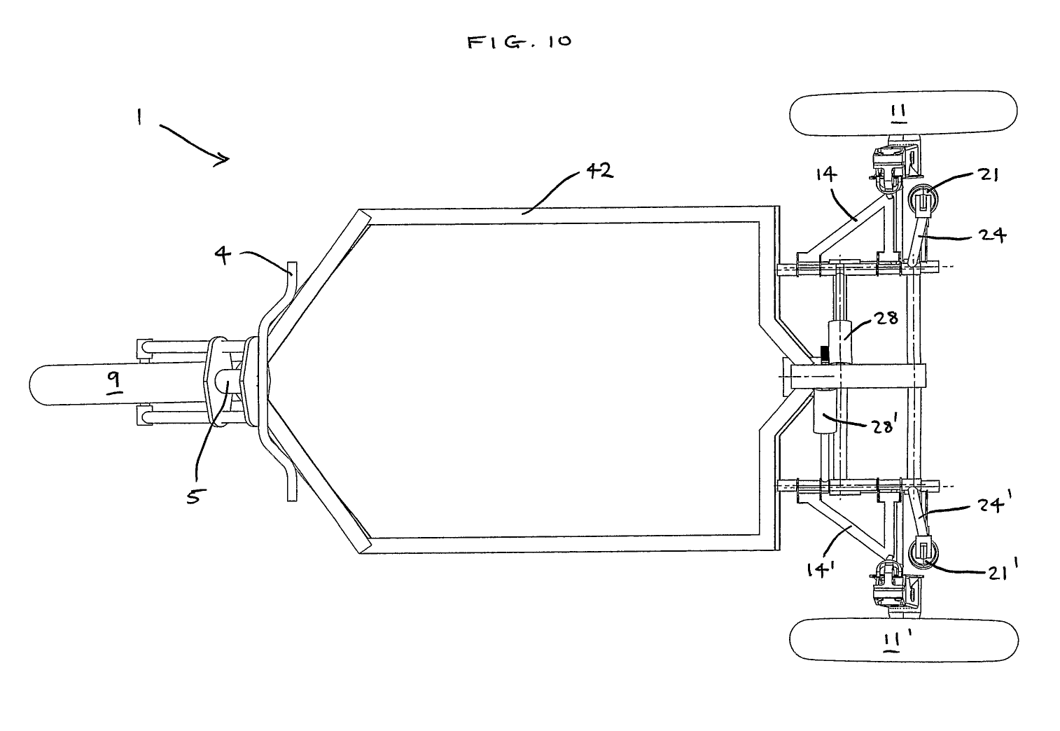

FIG. 10 is a schematic partial-plan view from above of the amphibian of FIG. 6, shown in a land mode with wheel and suspension assemblies protracted;

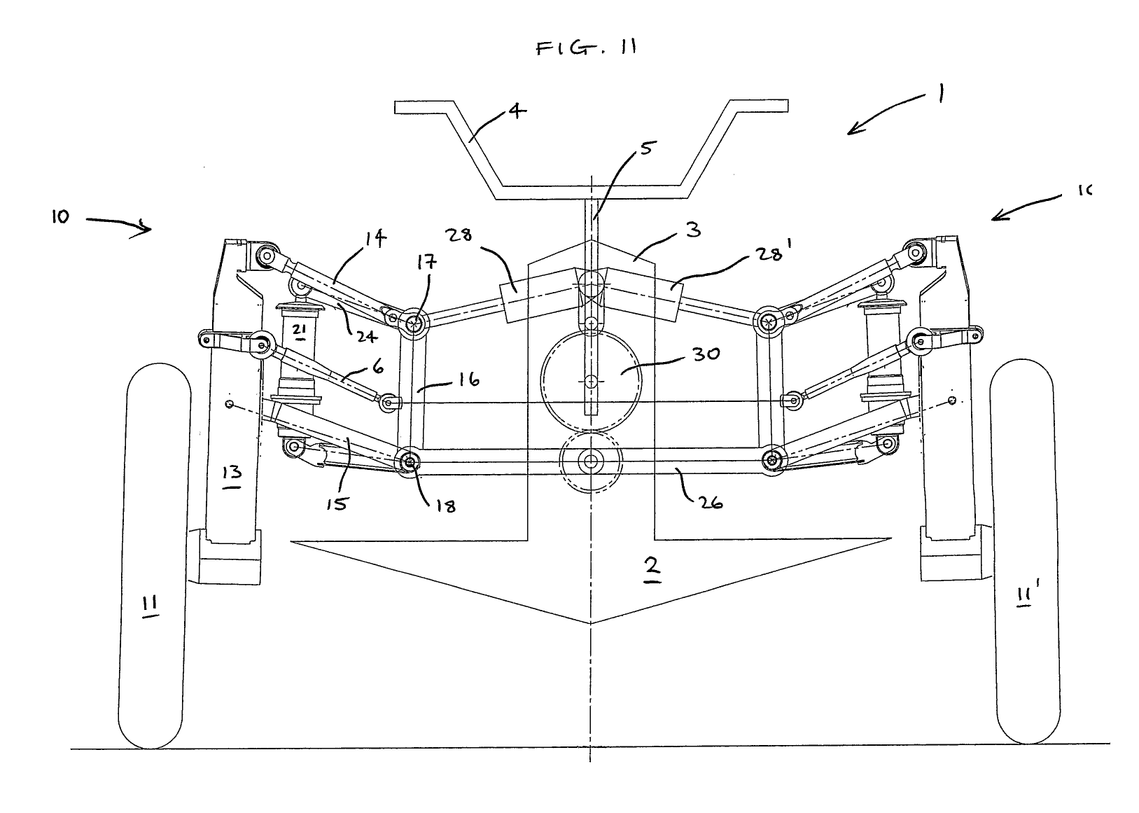

FIG. 11 is a schematic partial-front elevation view of a four-wheeled amphibian according to a third preferred embodiment of the present invention, shown in a land mode with wheel and suspension assemblies protracted;

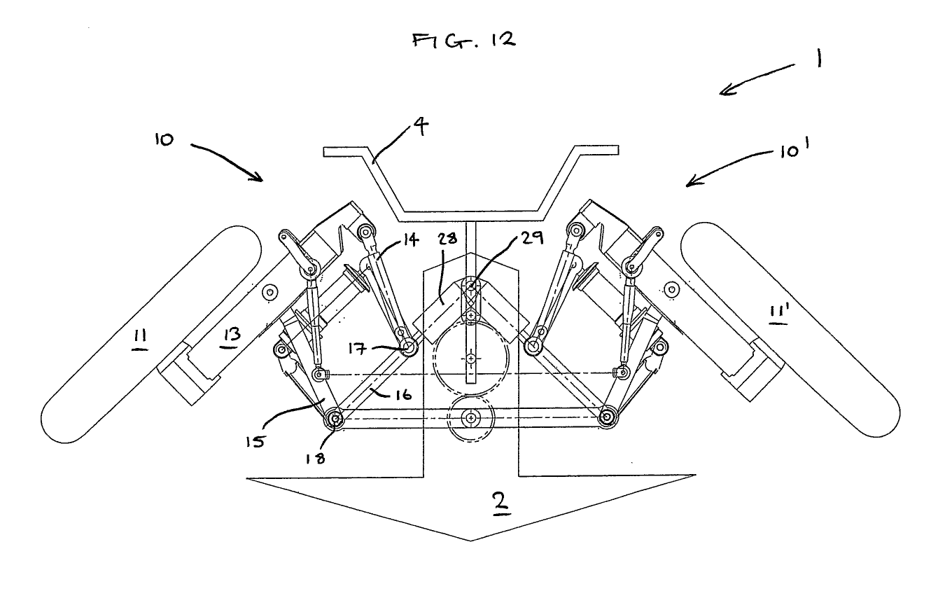

FIG. 12 is a schematic partial-front elevation view of the amphibian of FIG. 11, shown in a marine mode with wheel and suspension assemblies retracted;

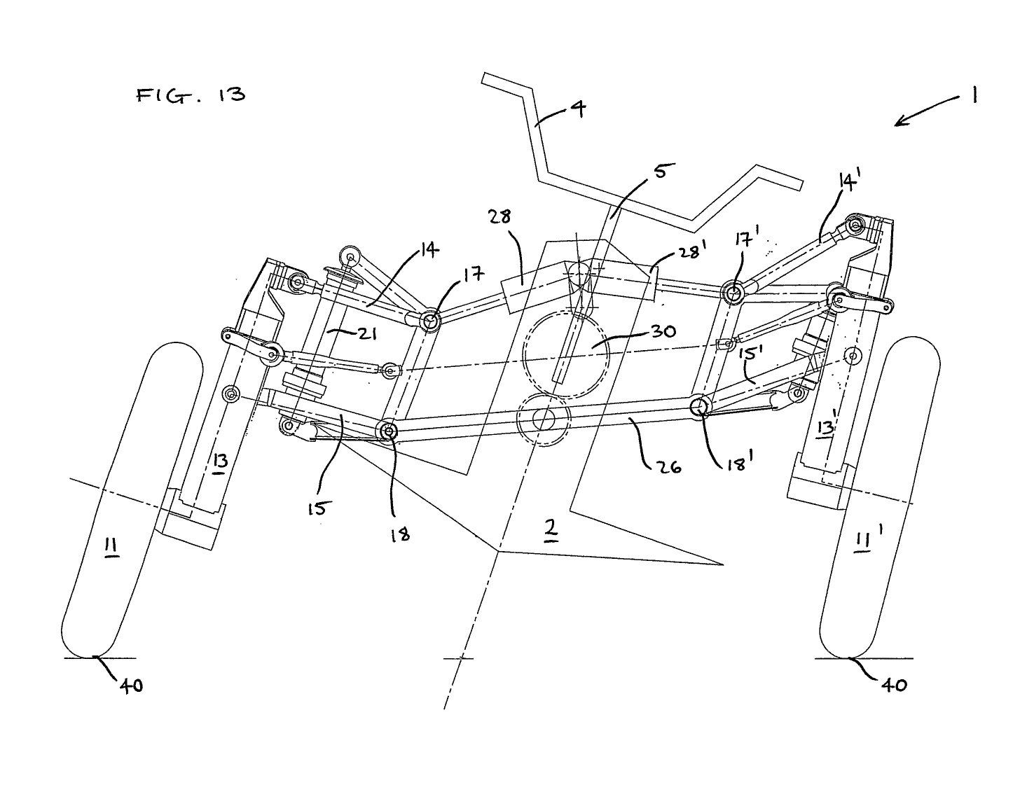

FIG. 13 is a schematic partial-front elevation view of the amphibian of FIG. 11, shown cornering or leaning on land in a land mode;

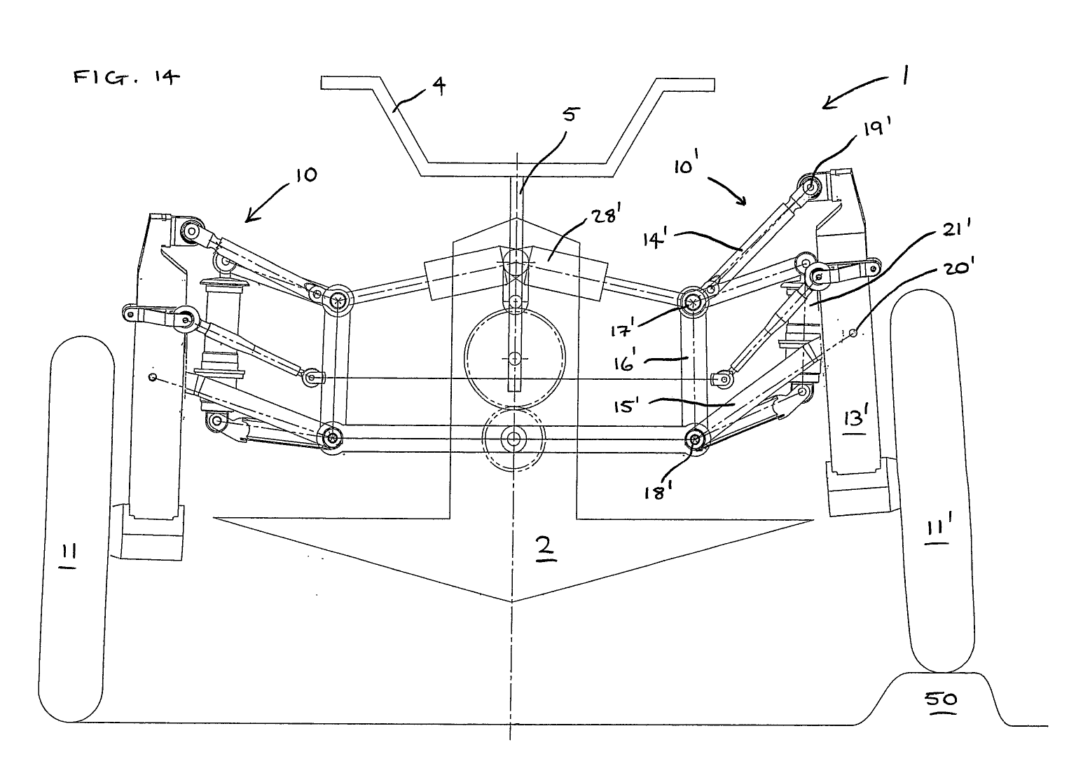

FIG. 14 is a schematic partial-front elevation view of the amphibian of FIG. 11, showing operation of a suspension assembly in bump travel in a land mode; and

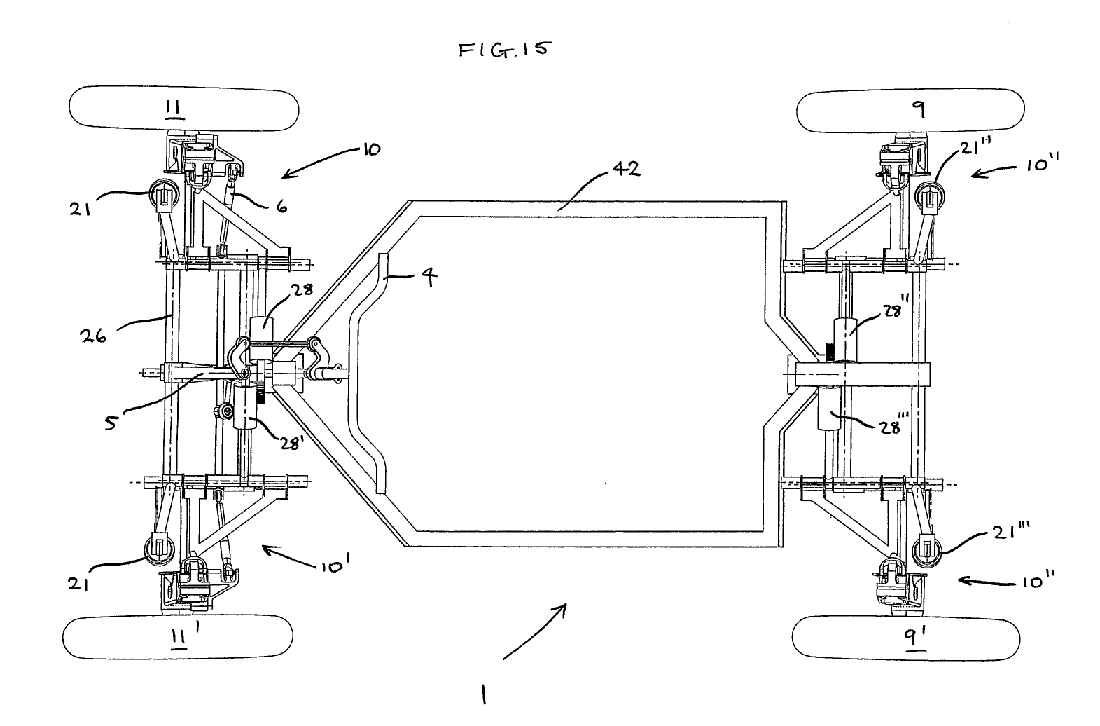

FIG. 15 is a schematic partial-plan view from above of the amphibian of FIG. 11, shown in a land mode with wheel and suspension assemblies protracted.

Referring first to FIGS. 1 to 5, there is shown a three-wheeled amphibian having a two front one rear wheel configuration, the amphibian being indicated in general by reference 1. The amphibian 1 is provided with a hull section 2 and a body 3. Handlebars 4 are provided at an upper region of the amphibian 1 and are connected to a steering column 5 which transcends downwardly towards the ground upon which the amphibian 1 is resting. A pivotally mounted steering arm 6 is connected to the steering column 5 and has pivot points 7 and 8 for connection with a suspension assembly of the present invention. A rear wheel 9 is provided.

The amphibian 1 includes a first suspension assembly 10, a corresponding second suspension assembly 10′ and a wheel 11, 11′ for each suspension assembly 10, 10′, each wheel 11, 11′ being mounted to a wheel hub mount 12, 12′ of the suspension assembly 10, 10′. Both suspension assemblies 10, 10′ are the same and, therefore, only suspension assembly 10 will be described in detail below. However, when referring to the second suspension assembly 10′, the suffix prime will always be used for its like numbered components. The suspension assembly 10 is provided with a suspension upright 13 which is connected to upper and lower suspension arms 14, 15. The upper and lower suspension arms 14, 15 are separated at a first end by an upright arm 16. The upper suspension arm 14 includes a pivotal connection 17 and the lower suspension arm 15 includes a pivotal connection 18, which pivotal connections 17, 18 allow respective movement between the upper suspension arm 14, the lower suspension arm 15 and the upright arm 16, at each end of the upright arm 16. The upper suspension arm 14 is provided at a second end with a further pivotal connection 19 which connects the upper suspension arm with the suspension upright 13, allowing movement of the two parts 14, 13. Conversely, the lower suspension arm 15 is provided at a second end with a second pivotal connection 20, which connects that suspension arm 15 with the suspension upright 13, allowing movement of the two parts 15, 13.

A damper 21 is provided that is connected at a first lower end to one end of a lower control arm 22 through a pivotal connection 23. This damper is surrounded by a coil suspension spring (not shown). The control arm 22 is fixed to the lower suspension arm 15 at its other end. The second upper end of the damper 21 is connected to a first end of control arm 24 by a pivotal connection 25. The other end of control arm 24 is fixed to upright 16. Conversely, upper suspension arm 14, is pivotally connected to upright 16 and therefore arm 24 through a pivotal connection 17. Each wheel suspension therefore acts as a double wishbone suspension due to having parallel arms 14 and 15, but the upper ends of the spring and damper 21 are constrained to compress on bump travel by the fixing of upper arm 24 to upright 16, so that upper arm 24 cannot rotate in bump and rebound. Pivotal connections 23 and 25 include rubber bushes (not shown) to allow some relative movements due to the geometric conflicts inherent in this design.

The lower suspension arm 15 and the upright 16 are pivotally connected at pivotal connection 18 to a lower link arm 26, which is pivotally connected at 27 to the body 3 of the amphibian 1. Owing to pivotal connection 27, the suspension apparatus 10 is moveable with respect to the body of the amphibian 1, so as to allow the amphibian 1 to lean when cornering. Further, the upper suspension arm 14 and upright arm 16 are pivotally connected at 17 to a retraction ram 28, for moving the suspension apparatus 10 from its protracted land mode position to its retracted marine mode position. A second end of the retraction ram 28 is connected to a first end of a drop link 31 by a pivotal connection 29. The drop link 31 is in turn connected to the body 3 by a further pivotal connection 32 at a second end. The pivotal connection 32 connects the drop link 31 to the body 3 and allows the drop link 31 to rotate during cornering of the amphibian 1, and when displaced by the retraction rams 28, 28′ when leaning.

FIG. 2 shows the amphibian 1 in its marine mode, with wheels retracted. Each of the suspension apparati 10, 10′ have been retracted and are now raised above the hull section 2 of the amphibian 1. Owing to the arrangement of the pivotal connections between upper and lower suspension arms 14, 15 and the upright arm 16—through pivotal connections 18 and 17 in particular—by retracting the retraction ram 28 and, therefore, by shortening the distance between the pivotal connection 17 and pivotal connection 29 on the body 3, each suspension apparatus 10, 10′ has been retracted to prevent fouling of the wheels 11, 11′ and/or parts of the suspension apparati 10, 10′ when used on water.

Referring again generally to FIGS. 1 to 5, a motor and gearbox assembly 30 is attached to the body 3. Through the actions of pivotal connections 27, 29, and 32, assembly 30 allows or provides for controlled lean of the amphibian 1. In particular, such control of the amphibian 1 dictates the amount of lean when cornering and, for example, keeps the amphibian 1 upright when stationary. The motor may be an electrical, particularly a stepper motor, or a hydraulic or pneumatic motor, and is attached to the body 3. When the amphibian 1 is stationary and not in use, the gearbox assembly may lock pivots 27, 29, and 32, preventing undesired lean of the amphibian 1.

FIG. 3 shows the amphibian 1 when leaning during cornering. By way of example, if the amphibian 1 is moving forward out from the page, the amphibian is turning left in FIG. 3. All three wheels 11, 11′, 9 alter their orientation with respect to the ground such that a more peripheral part 40 of each wheel 11, 11′, 9 contacts the ground when cornering—in the same way that this occurs when cornering on a motorbike. In comparison with FIG. 1, the body 3′ of FIG. 3 is now leant over at the same angle as the suspension uprights 13, 13′. The suspension assembly 10 is on an outside of a corner and the suspension assembly 10′ is on an inside of a corner. In order to accommodate this, the link arm 26 has rotated around the pivotal connection 27 and the retraction rams 28, 28′ have rotated around the pivotal connection 32 via drop link 31, to alter the orientation of the suspension assemblies 10, 10′. At the same time, on assembly 10, the suspension arms 14, 15 have rotated downwardly around the pivotal connections 17, 18 in order to allow the wheel 11 to stay on the ground. In doing this, the spring and damper 21 have been extended and the relative position of the upper suspension arm 14 with respect to the damper 21 is lowered, as can be seen from comparing FIGS. 1 and 3. Therefore, it will be understood that for suspension assembly 10 to be on an outside of a corner, the assembly must be able to place the wheel 11 in a relative lower position than the wheel 11 would be in, in an upright rest position of the amphibian 1. Further, on assembly 10′, the suspension arms 14′, 15′ have rotated upwardly around the pivotal connections 17′, 18′ in order to allow the other wheel 11′ to stay on the ground. In doing this, the spring and damper 21′ have been shortened and the relative position of the upper suspension arm 14′ with respect to the damper 21′ is heightened, as can be seen from comparing FIGS. 1 and 3. Therefore, it will be understood that for suspension assembly 10′ to be on an inside of a corner, the assembly 10′ must be able to place the wheel 11′ in a relative higher position than the wheel 11′ would be in, in an upright rest position of the amphibian 1.

Operation of the amphibian suspension in bump travel is shown in FIG. 4. The suspension assemblies 10, 10′ are shown in their protracted, land-use positions. The suspension assembly 10 is shown traversing flat ground and the suspension assembly 10′ is traversing a bump 50. Owing to the arrangement of the upper and lower suspension arms 14′, 15′ being similar to a double wishbone suspension, both suspension arms 14′, 15′ are raised to accommodate the bump 50. The pivotal connections 17′, 18′, 19′, 20′ allow rotation of the suspension arms 14′, 15′ to substantially maintain the orientation of the wheel with respect to the ground. At the same time the spring and damper 21 has been compressed.

FIG. 5 is a schematic partial-plan view from above of the amphibian 1, shown in a land mode with wheel and suspension assemblies protracted. This Figure illustrates the two front one rear wheel configuration, the amphibian 1 having two front wheels 11, 11′ and a single rear wheel 9. A chassis frame 42 is provided, and a rear wheel retraction ram 49.

Powered lean of the amphibian 1 can be provided by suitably controlling the pivotal connections 27 and/or 29. The motor and gearbox 30 may either provide resistance to rotation of the retraction rams 28, 28′ and/or link arm 26, or may power rotation of those parts. Further, the retraction rams 28, 28′ themselves can be used to alter the orientation of the wheels 11, 11′, 9 when cornering.

Referring next to FIGS. 6 to 10, there is shown a three-wheeled amphibian having a one front two rear wheel configuration, the amphibian being indicated in general by reference 1. The amphibian 1 is provided with a hull section 2 and a body 3. Handlebars 4 are provided at an upper region of the amphibian 1 and are connected to a steering column 5 which transcends downwardly towards the ground upon which the amphibian 1 is resting, and connecting with forks supporting the front wheel 9. A front wheel 9 and rear wheels 11, 11′ are provided.

The amphibian 1 includes a first suspension assembly 10, a corresponding second suspension assembly 10′ and a wheel 11, 11′ for each suspension assembly 10, 10′, each wheel 11, 11′ being mounted to a wheel hub mount 12, 12′ of the suspension assembly 10, 10′. Both suspension assemblies 10, 10′ are the same and, therefore, only suspension assembly 10 will be described in detail below. However, when referring to the second suspension assembly 10′, the suffix prime will always be used for its like numbered components. The suspension assembly 10 is provided with a suspension upright 13 which is connected to upper and lower suspension arms 14, 15. The upper and lower suspension arms 14, 15 are separated at a first end by an upright arm 16. The upper suspension arm 14 includes a pivotal connection 17 and the lower suspension arm 15 includes a pivotal connection 18, which pivotal connections 17, 18 allow respective movement between the upper suspension arm 14, the lower suspension arm 15 and the upright arm 16, at each end of the upright arm 16. The upper suspension arm 14 is provided at a second end with a further pivotal connection 19 which connects the upper suspension arm with the suspension upright 13, allowing movement of the two parts 14, 13. Conversely, the lower suspension arm 15 is provided at a second end with a second pivotal connection 20, which connects that suspension arm 15 with the suspension upright 13, allowing movement of the two parts 15, 13.

A damper 21 is provided that is connected at a first lower end to one end of a lower control arm 22 through a pivotal connection 23. This damper is surrounded by a coil suspension spring (not shown). The control arm 22 is fixed to the lower suspension arm 15 at its other end. The second upper end of the damper 21 is connected to a first end of control arm 24 by a pivotal connection 25. The other end of control arm 24 is fixed to upright 16. Conversely, upper suspension arm 14, is pivotally connected to upright 16 and therefore arm 24 through a pivotal connection 17. Each wheel suspension therefore acts as a double wishbone suspension due to having parallel arms 14 and 15, but the upper ends of the spring and damper 21 are constrained to compress on bump travel by the fixing of upper arm 24 to upright 16, so that upper arm 24 cannot rotate in bump and rebound. Pivotal connections 23 and 25 include rubber bushes (not shown) to allow some relative movements due to the geometric conflicts inherent in this design.

The lower suspension arm 15 and the upright 16 are pivotally connected at pivotal connection 18 to a lower link arm 26, which is pivotally connected at 27 to the body 3 of the amphibian 1. Owing to pivotal connection 27, the suspension apparatus 10 is moveable with respect to the body of the amphibian 1, so as to allow the amphibian 1 to lean when cornering. Further, the upper suspension arm 14 and upright arm 16 are pivotally connected at 17 to a retraction ram 28, for moving the suspension apparatus 10 from its protracted land mode position to its retracted marine mode position. A second end of the retraction ram 28 is connected to a first end of a drop link 31 by a pivotal connection 29. The drop link 31 is in turn connected to the body 3 by a further pivotal connection 32 at a second end. The pivotal connection 32 connects the drop link 31 to the body 3 and allows the drop link 31 to rotate during cornering of the amphibian 1, and when displaced by the retraction rams 28, 28′ when leaning.

FIG. 7 shows the amphibian 1 in its marine mode, with wheels retracted. Each of the suspension apparati 10, 10′ have been retracted and are now raised above the hull section 2 of the amphibian 1. Owing to the arrangement of the pivotal connections between upper and lower suspension arms 14, 15 and the upright arm 16≠through pivotal connections 18 and 17 in particular—by retracting the retraction ram 28 and, therefore, by shortening the distance between the pivotal connection 17 and pivotal connection 29 on the body 3, each suspension apparatus 10, 10′ has been retracted to prevent fouling of the wheels 11, 11′ and/or parts of the suspension apparati 10, 10′ when used on water.

Referring again generally to FIGS. 6 to 10, a motor and gearbox assembly 30 is attached to the body 3. Through the actions of pivotal connections 27, 29, and 32, assembly 30 allows or provides for controlled lean of the amphibian 1. In particular, such control of the amphibian 1 dictates the amount of lean when cornering and, for example, keeps the amphibian 1 upright when stationary. The motor may be an electrical, particularly a stepper motor, or a hydraulic or pneumatic motor, and is attached to the body 3. When the amphibian 1 is stationary and not in use, the gearbox assembly may lock pivots 27, 29, and 32, preventing undesired lean of the amphibian 1.

FIG. 8 shows the amphibian 1 when leaning during cornering. By way of example, if the amphibian 1 is moving forward out from the page, the amphibian is turning left in FIG. 3. All three wheels 11, 11′, 9 alter their orientation with respect to the ground such that a more peripheral part 40 of each wheel 11, 11′, 9 contacts the ground when cornering—in the same way that this occurs when cornering on a motorbike. In comparison with FIG. 1, the body 3′ of FIG. 3 is now leant over at the same angle as the suspension uprights 13, 13′. The suspension assembly 10 is on an outside of a corner and the suspension assembly 10′ is on an inside of a corner. In order to accommodate this, the link arm 26 has rotated around the pivotal connection 27 and the retraction rams 28, 28′ have rotated around the pivotal connection 32 via drop link 31, to alter the orientation of the suspension assemblies 10, 10′. At the same time, on assembly 10, the suspension arms 14, 15 have rotated downwardly around the pivotal connections 17, 18 in order to allow the wheel 11 to stay on the ground. In doing this, the spring and damper 21 have been extended and the relative position of the upper suspension arm 14 with respect to the damper 21 is lowered, as can be seen from comparing FIGS. 1 and 3. Therefore, it will be understood that for suspension assembly 10 to be on an outside of a corner, the assembly must be able to place the wheel 11 in a relative lower position than the wheel 11 would be in, in an upright rest position of the amphibian 1. Further, on assembly 10′, the suspension arms 14′, 15′ have rotated upwardly around the pivotal connections 17′, 18′ in order to allow the other wheel 11′ to stay on the ground. In doing this, the spring and damper 21′ have been shortened and the relative position of the upper suspension arm 14′ with respect to the damper 21′ is heightened, as can be seen from comparing FIGS. 1 and 3. Therefore, it will be understood that for suspension assembly 10′ to be on an inside of a corner, the assembly 10′ must be able to place the wheel 11′ in a relative higher position than the wheel 11′ would be in, in an upright rest position of the amphibian 1.

Operation of the amphibian suspension in bump travel is shown in FIG. 9. The suspension assemblies 10, 10′ are shown in their protracted, land-use positions. The suspension assembly 10 is shown traversing flat ground and the suspension assembly 10′ is traversing a bump 50. Owing to the arrangement of the upper and lower suspension arms 14′, 15′ being similar to a double wishbone suspension, both suspension arms 14′, 15′ are raised to accommodate the bump 50. The pivotal connections 17′, 18′, 19′, 20′ allow rotation of the suspension arms 14′, 15′ to substantially maintain the orientation of the wheel with respect to the ground. At the same time the spring and damper 21 has been compressed.

FIG. 10 is a schematic partial-plan view from above of the amphibian 1 of FIGS. 6 to 9, shown in a land mode with wheel and suspension assemblies protracted. This Figure illustrates the one front two rear wheel configuration, the amphibian 1 having a single front wheel 9 and two rear wheels 11, 11′. A chassis frame 42 is provided, and a front wheel retraction ram (not shown) similar to the rear wheel retraction ram 49 shown in FIG. 5.

Powered lean of the amphibian 1 can be provided by suitably controlling the pivotal connections 27 and/or 29. The motor and gearbox 30 may either provide resistance to rotation of the retraction rams 28, 28′ and/or link arm 26, or may power rotation of those parts. Further, the retraction rams 28, 28′ themselves can be used to alter the orientation of the wheels 11, 11′, 9 when cornering.

Referring next to FIGS. 11 to 15, there is shown a four-wheeled amphibian having a two front two rear wheel configuration, the amphibian being indicated in general by reference 1. The amphibian 1 is provided with a hull section 2 and a body 3. Handlebars 4 are provided at an upper region of the amphibian 1 and are connected to a steering column 5 which transcends downwardly towards the ground upon which the amphibian 1 is resting. A pivotally mounted steering arm 6 is connected to the steering column 5 and has pivot points 7 and 8 for connection with a suspension assembly of the present invention. Two rear wheels 9, 9′ are provided. In an alternative embodiment, the amphibian 1 may have four-wheel steering and be provided with steering mechanisms at the front and rear.

The amphibian 1 includes a first suspension assembly 10, a corresponding second suspension assembly-10′ and a wheel 11, 11′ for each suspension assembly 10, 10′, each wheel 11, 11′ being mounted to a wheel hub mount 12, 12′ of the suspension assembly 10, 10′. Similarly, the amphibian 1 includes third and fourth suspension assemblies 10″, 10′″and wheels 9, 9′ for each suspension assembly 10″, 10′″, each wheel 9, 9′ being mounted to a wheel hub mount 12′, 12′″ of the suspension assembly 10″, 10′″. Both suspension assemblies 10″, 10′″ are substantially the same as suspension assemblies 10, 10′ (differing only in terms of facing direction) and, therefore, only suspension assembly 10 will be described in detail below. However, when referring to the second, third and fourth suspension assemblies 10′, 10″, 10′″, the suffix prime(s) will always be used for its like numbered components. The suspension assembly 10 is provided with a suspension upright 13 which is connected to upper and lower suspension arms 14, 15. The upper and lower suspension arms 14, 15 are separated at a first end by an upright arm 16. The upper suspension arm 14 includes a pivotal connection 17 and the lower suspension arm 15 includes a pivotal connection 18, which pivotal connections 17, 18 allow respective movement between the upper suspension arm 14, the lower suspension arm 15 and the upright arm 16, at each end of the upright arm 16. The upper suspension arm 14 is provided at a second end with a further pivotal connection 19 which connects the upper suspension arm with the suspension upright 13, allowing movement of the two parts 14, 13. Conversely, the lower suspension arm 15 is provided at a second end with a second pivotal connection 20, which connects that suspension arm 15 with the suspension upright 13, allowing movement of the two parts 15, 13.

A damper 21 is provided that is connected at a first lower end to one end of a lower control arm 22 through a pivotal connection 23. This damper is surrounded by a coil suspension spring (not shown). The control arm 22 is fixed to the lower suspension arm 15 at its other end. The second upper end of the damper 21 is connected to a first end of control arm 24 by a pivotal connection 25. The other end of control arm 24 is fixed to upright 16. Conversely, upper suspension arm 14, is pivotally connected to upright 16 and therefore arm 24 through a pivotal connection 17. Each wheel suspension therefore acts as a double wishbone suspension due to having parallel arms 14 and 15, but the upper ends of the spring and damper 21 are constrained to compress on bump travel by the fixing of upper arm 24 to upright 16, so that upper arm 24 cannot rotate in bump and rebound. Pivotal connections 23 and 25 include rubber bushes (not shown) to allow some relative movements due to the geometric conflicts inherent in this design.

The lower suspension arm 15 and the upright 16 are pivotally connected at pivotal connection 18 to a lower link arm 26, which is pivotally connected at 27 to the body 3 of the amphibian 1. Owing to pivotal connection 27, the suspension apparatus 10 is moveable with respect to the body of the amphibian 1, so as to allow the amphibian 1 to lean when cornering. Further, the upper suspension arm 14 and upright arm 16 are pivotally connected at 17 to a retraction ram 28, for moving the suspension apparatus 10 from its protracted land mode position to its retracted marine mode position. A second end of the retraction ram 28 is connected to a first end of a drop link 31 by a pivotal connection 29. The drop link 31 is in turn connected to the body 3 by a further pivotal connection 32 at a second end. The pivotal connection 32 connects the drop link 31 to the body 3 and allows the drop link 31 to rotate during cornering of the amphibian 1, and when displaced by the retraction rams 28, 28′ when leaning.

FIG. 12 shows the amphibian 1 in its marine mode, with wheels retracted. Each of the suspension apparati 10, 10′, 10″, 10′″ have been retracted and are now raised above the hull section 2 of the amphibian 1. Owing to the arrangement of the pivotal connections between upper and lower suspension arms 14, 15 and the upright arm 16—through pivotal connections 18 and 17 in particular—by retracting the retraction ram 28 and, therefore, by shortening the distance between the pivotal connection 17 and pivotal connection 29 on the body 3, each suspension apparatus 10, 10′, 10″, 10′″ has been retracted to prevent fouling of the wheel 11 and/or parts of the suspension apparatus 10 when used on water.

Referring again generally to FIGS. 11 to 15, a motor and gearbox assembly 30 is attached to the body 3. Through the actions of pivotal connections 27, 29, and 32, assembly 30 allows or provides for controlled lean of the amphibian 1. In particular, such control of the amphibian 1 dictates the amount of lean when cornering and, for example, keeps the amphibian 1 upright when stationary. The motor may be an electrical, particularly a stepper motor, or a hydraulic or pneumatic motor, and is attached to the body 3. When the amphibian 1 is stationary and not in use, the gearbox assembly may lock pivots 27, 29, and 32, preventing undesired lean of the amphibian 1.

FIG. 13 shows the amphibian 1 when leaning during cornering. By way of example, if the amphibian 1 is moving forward out from the page, the amphibian is turning left in FIG. 3. All four wheels 11, 11′, 9, 9′ alter their orientation with respect to the ground such that a more peripheral part 40 of each wheel 11, 11′, 9, 9′ contacts the ground when cornering—in the same way that this occurs when cornering on a motorbike. In comparison with FIG. 1, the body 3′ of FIG. 3 is now leant over at the same angle as the suspension uprights 13, 13′. The suspension assemblies 10, 10″ are on an outside of a corner and the suspension assemblies 10′, 10′″ are on an inside of a corner. In order to accommodate this, the link arm 26 has rotated around the pivotal connection 27 and the retraction rams 28, 28′ have rotated around the pivotal connection 32 via drop link 31, to alter the orientation of the suspension assemblies 10, 10′, 10″, 10′″. At the same time, on assembly 10, the suspension arms 14, 15 have rotated downwardly around the pivotal connections 17, 18 in order to allow the wheel 11 to stay on the ground. In doing this, the spring and damper 21 have been extended and the relative position of the upper suspension arm 14 with respect to the damper 21 is lowered, as can be seen from comparing FIGS. 1 and 3. Therefore, it will be understood that for suspension assemblies 10, 10″ to be on an outside of a corner, the assemblies must be able to place the wheels 11, 9 in a relative lower position than the wheels 11, 9 would be in, in an upright rest position of the amphibian 1. Further, on assemblies 10′, 10′″ the suspension arms 14′, 15′ have rotated upwardly around the pivotal connections 17′, 18′ in order to allow the other wheels 11′, 9′ to stay on the ground. In doing this, the spring and damper 21′ have been shortened and the relative position of the upper suspension arm 14′ with respect to the damper 21′ is heightened, as can be seen from comparing FIGS. 1 and 3. Therefore, it will be understood that for suspension assemblies 10′, 10′″ to be on an inside of a corner, the assemblies 10′, 10′″ must be able to place the wheels 11′, 9′ in a relative higher position than the wheel 11′, 9′ would be in, in an upright rest position of the amphibian 1.

Operation of the amphibian suspension in bump and rebound is shown in FIG. 14. The suspension assemblies 10, 10′, 10″, 10′″ are shown in their protracted, land-use positions. The suspension assembly 10 is shown traversing flat ground and the suspension assembly 10′ is traversing a bump 50. Owing to the arrangement of the upper and lower suspension arms 14′, 15′ being similar to a double wishbone suspension, both suspension arms 14′, 15′ are raised to accommodate the bump 50. The pivotal connections 17′, 18′, 19′, 20′ allow rotation of the suspension arms 14′, 15′ to substantially maintain the orientation of the wheel with respect to the ground. At the same time the spring and damper 21 has been compressed.

FIG. 15 is a schematic partial-plan view from above of the amphibian 1 of FIGS. 11 to 14, shown in a land mode with wheel and suspension assemblies protracted. This Figure illustrates the two front two rear wheel configuration, the amphibian 1 having two front wheels 11, 11′ and two rear wheels 9, 9′.

Powered lean of the amphibian 1 can be provided by suitably controlling the pivotal connections 27 and/or 29. The motor and gearbox 30 may either provide resistance to rotation of the retraction rams 28, 28′ and/or link arm 26, or may power rotation of those parts. Further, the retraction rams 28, 28′ themselves can be used to alter the orientation of the wheels 11, 11′, 9, 9′ when cornering.

Although the retractable leaning suspension assembly 10, 10′, 10″, 10′″ has been described in the context of an amphibian 1 where all three or four wheels lean, it may also be applied to a three-wheeled amphibian 1 whose single rear or front wheel does not lean, but rolls in corners as a car tyre does.

It will be noted that a vee-type hull 2 is shown in the Figures, and this is generally chosen for a planing amphibian 1 to give agile handling in marine mode. However, it will also be noted from the Figures that this hull 2 form is advantageous for a leaning amphibian 1 on land, in that ground clearance is maintained as the amphibian 1 leans, up to a lean angle corresponding at least to the vee angle of the hull 2.

Whilst the amphibian according to the present invention has been described herein as a three- or four-wheeled amphibian, this is to be taken as meaning that the amphibian has three or four wheel receiving stations, with at least one wheel provided at each wheel station. It is of course possible for a wheel provided at a wheel station to in fact comprise two or more thin wheels provided side by side.

Although several embodiments of amphibian have been described above, any one or more or all of the features described (and/or claimed in the appended claims) may be provided in isolation or in various combinations in any of the embodiments. As such, any one or more these features may be removed, substituted and/or added to any of the feature combinations described and/or claimed. For the avoidance of doubt, any of the features of any embodiment may be combined with any other feature from any of the embodiments.

Accordingly, whilst preferred embodiments of the present invention have been described above and illustrated in the drawings, these are by way of example only and non-limiting. It will be appreciated by those skilled in the art that many alternatives are possible within the ambit of the invention, as set out in the appended claims.

1. A three- or four-wheeled amphibian for use on land and water comprising one or two front steered wheels, one or two rear wheels, and a hull section, each steered wheel being connected to the amphibian by a retractable suspension assembly comprising one or more suspension arms, one or more pivotal connections for the one or more suspension arms, and retraction means connected to the one or more suspension arms which, in use, acts upon the one or more suspension arms to provide movement between a protracted land-use position and a retracted water-use position of each steered wheel, wherein the retraction means is movably-connected to the amphibian to accommodate an alteration of orientation of the one or more suspension arms of the steered wheel with respect to the ground upon which it stands when steering the steered wheel and/or leaning the amphibian, such that movement of the one or more suspension arms for retraction and protraction, and for altering orientation is accommodated through the same pivotal connection of the one or more pivotal connections.

2. A three- or four-wheeled amphibian as claimed in claim 1, wherein the retraction means is pivotally-connected to the amphibian.

3. A three- or four-wheeled amphibian as claimed in claim 1, wherein the retraction means comprises a drop link pivotally-connected to the body and separately, pivotally-connected to the retraction means.

4. A three- or four-wheeled amphibian as claimed in claim 1, wherein the retraction means comprises a centrally mounted drop link which is pivotally-connected to the body, and which is pivotally-connected to two retraction means, one being on each side of the drop link for a separate suspension assembly.

5. A three- or four-wheeled amphibian as claimed in claim 1, wherein the retraction means allows passive lean or user initiated lean of said amphibian when cornering against a resistance provided by the retraction means.

6. A three- or four-wheeled amphibian as claimed in claim 1, wherein the retraction means provides correction of passive or user-initiated lean through a counter force initiated by the passive or user-initiated lean.

7. A three- or four-wheeled amphibian as claimed in claim 1, wherein the retraction means provides powered correction of passive or user-initiated lean.

8. A three- or four-wheeled amphibian as claimed in claim 1, wherein the retraction means provides powered lean of said amphibian when cornering.

9. A three- or four-wheeled amphibian as claimed in claim 8, wherein the retraction means provides powered correction of lean when cornering.

10. A three- or four-wheeled amphibian as claimed in claim 1, comprising a damper operatively-connected to the upper and lower suspension arms, wherein the damper allows passive lean or user initiated lean of said amphibian when cornering against a resistance provided by the damper.

11. A three- or four-wheeled amphibian as claimed in claim 10, wherein the damper provides correction of passive or user initiated lean through a counter force initiated by the passive or user-initiated lean.

12. A three- or four-wheeled amphibian as claimed in claim 1, comprising leaning means which provides powered correction of passive or user-initiated lean.

13. A three- or four-wheeled amphibian as claimed in claim 1, comprising leaning means which provides powered lean of said amphibian when cornering.

14. A three- or four-wheeled amphibian as claimed in claim 13, wherein the leaning means provides powered correction of lean when cornering.

15. A three- or four-wheeled amphibian as claimed in claim 1, comprising one or more sensors for detecting velocity and/or degree of turning in order to provide a correct amount of lean, and/or yaw rate to detect skids.

16. A three- or four-wheeled amphibian as claimed in claim 1, wherein the suspension assembly comprises locking means to prevent uncontrolled and/or undesirable lean of said amphibian especially at low speed.

17. A three- or four-wheeled amphibian as claimed in claim 1, wherein the retraction means comprises an electrical, pneumatic or hydraulic arrangement.

18. A three- or four-wheeled amphibian as claimed in claim 1, wherein a single retraction means operates the retractable suspension assembly of both sides of said amphibian.

19. A three- or four-wheeled amphibian as claimed in claim 1, wherein a retraction means is provided for each suspension assembly.

20. A three- or four-wheeled amphibian as claimed in claim 1, wherein the one or more suspension arms comprise two suspension arms, one upper and one lower, which contact a suspension upright at respective upper and lower locations and which suspension upright receives the wheel.

21. A three- or four-wheeled amphibian as claimed in claim 20, wherein the lower suspension arm is pivotally-connected to a body of the amphibian, either directly or through other linkages.

22. A three- or four-wheeled amphibian as claimed in claim 20, wherein the retraction means is pivotally-connected to a/the body of the amphibian, either directly or through other linkages.

23. A three- or four-wheeled amphibian as claimed in claim 22, wherein the retraction means is pivotally-connected to the upper suspension arm and an upright arm.

24. A three- or four-wheeled amphibian as claimed in claim 20, wherein the upper and lower suspension arms are pivotally-connected to an/the upright arm, which maintains the separation distance of the arms.

25. A three- or four-wheeled amphibian as claimed in claim 1, comprising one or more steering arms to allow the suspension assembly to be steered in use.

26. A three- or four-wheeled amphibian as claimed in claim 1, comprising drive means to provide drive to the front and/or rear wheel(s).

27. A three- or four-wheeled amphibian as claimed in claim 1, comprising left- and right-hand steered wheels which are operably-connected so as to move together through turning and through altering orientation thereof.

28. A three- or four-wheeled amphibian as claimed in claim 27, wherein the left- and right-hand steered wheels are further pivotally-mounted to the body of the amphibian through a common linkage to further accommodate for leaning of the amphibian.

29. A three- or four-wheeled amphibian as claimed in claim 1, wherein the left- and right-hand steered wheels are further pivotally-mounted to the body of the amphibian through separate linkages to further accommodate for leaning of the amphibian.

30. A three- or four-wheeled amphibian as claimed in claim 1, wherein the rear wheel or wheels is/are retractable.

31. A three- or four-wheeled amphibian as claimed in claim 1, comprising a Vee-type hull.

32. A suspension assembly for an amphibian comprising:
one or more suspension arms comprising a wheel hub mount for receiving a wheel, which arms is/are capable of connecting with said amphibian;
one or more pivotal connections for the one or more suspension arms; and
retraction means connected to the one or more suspension arms and movably-connectable with said amphibian for, in use, moving the one or more suspension arms around the one or more pivotal connections with respect to said amphibian between a protracted land-use position and a retracted water-use position,
wherein, in the protracted land-use position, the one or more suspension arms are further moveable around the one or more pivotal connections to alter orientation of the wheel hub mount with respect to the ground when steering and/or leaning of said amphibian, such that movement of the one or more suspension arms for retraction and protraction, and for altering orientation is accommodated through the same pivotal connection of the one or more pivotal connections.

33. A suspension assembly as claimed in claim 32, wherein the retraction means allows passive lean or user initiated lean of said amphibian when cornering against a resistance provided by the retraction means.

34. A suspension assembly as claimed in claim 32, wherein the retraction means provides correction of passive or user-initiated lean through a counter force initiated by the passive or user-initiated lean.

35. A suspension assembly as claimed in claim 32 wherein the retraction means provides powered correction of passive or user-initiated lean.

36. A suspension assembly as claimed in claim 32, wherein the retraction means provides powered lean of said amphibian when cornering.

37. A suspension assembly as claimed in claim 36, wherein the retraction means provides powered correction of lean when cornering.

38. A suspension assembly as claimed in claim 32, comprising a damper operatively-connected to the upper and lower suspension arms, wherein the damper allows passive lean or user initiated lean of said amphibian when cornering against a resistance provided by the damper.

39. A suspension assembly as claimed in claim 38, wherein the damper provides correction of passive or user-initiated lean through a counter force initiated by the passive or user-initiated lean.

40. A suspension assembly as claimed in claim 32, comprising leaning means which provides powered correction of passive or user-initiated lean.

41. A suspension assembly as claimed in claim 32, comprising leaning means which provides powered lean of said amphibian when cornering.

42. A suspension assembly as claimed in claim 41, wherein the leaning means provides powered correction of lean when cornering.

43. A suspension assembly as claimed in claim 32, wherein the assembly comprises one or more sensors for detecting velocity and/or degree of turning of said amphibian in order to provide a correct amount of lean, and/or yaw rate to detect skids.

44. A suspension assembly as claimed in claim 32, wherein the suspension assembly comprises locking means to prevent uncontrolled and/or undesirable lean of said amphibian.

45. A suspension assembly as claimed in claim 32, wherein the retraction means comprises an electrical, pneumatic or hydraulic arrangement.

46. A suspension assembly as claimed in claim 32, wherein a single retraction means operates two suspension assemblies for both sides of said amphibian.

47. A suspension assembly as claimed in claim 32, wherein a retraction means is provided for each suspension assembly.

48. A suspension assembly as claimed in claim 32, wherein the lower suspension arm is pivotally-connectable to a body of said amphibian, either directly or through other linkages.

49. A suspension assembly as claimed in claim 32, wherein the retraction means is pivotally-connectable to a body of said amphibian, either directly or through other linkages.

50. A suspension assembly as claimed in claim 32, wherein the one or more suspension arms comprise two suspension arms, one upper and one lower, which contact a suspension upright at respective upper and lower locations.

51. A suspension assembly as claimed in claim 50, wherein the upper and lower suspension arms are pivotally-connected to the suspension upright.

52. A suspension assembly as claimed in claim 32, wherein the upper and lower suspension arms are pivotally-connected to an upright arm, which maintains the separation distance of the arms.

53. A suspension assembly as claimed in claim 32, wherein the retraction means is pivotally-connected to the upper suspension arm and the upright arm.

54. A suspension assembly as claimed in claim 32, comprising one or more steering arms to allow the suspension assembly to be steered in use.

55. A suspension assembly as claimed in claim 32, comprising drive means to provide drive to the wheel hub.

56. A suspension assembly as claimed in claim 32, wherein the retraction means is pivotally connectable to the amphibian.

57. A suspension assembly as claimed in claim 32, wherein the retraction means comprises a drop link pivotally-connectable to the body and separately, pivotally-connected to the retraction means.

58. A suspension assembly as claimed in claim 32, wherein the retraction means comprises a centrally mounted drop link which is pivotally-connectable to the body, and which is pivotally-connected to two retraction means, one being on each side of the drop link for a separate suspension assembly.

59. An amphibian incorporating the suspension assembly as claimed in claim 32.

60-61. (canceled)

62. A three- or four-wheeled amphibian for use on land and water comprising two front steered wheels, one rear wheel and a hull section, each steered wheel being connected to the amphibian by a retractable suspension assembly comprising one or more suspension arms, one or more pivotal connections for the one or more suspension arms, and retraction means connected to the one or more suspension arms which, in use, acts upon the one or more suspension arms to provide movement between a protracted land-use position and a retracted water-use position of each steered wheel, wherein the retraction means also acts, in use, upon the one or more suspension arms to alter orientation of the steered wheel with respect to the ground upon which it stands when steering the steered wheel and/or leaning the amphibian, such that movement of the one or more suspension arms for retraction and protraction, and for altering orientation is accommodated through the same pivotal connection of the one or more pivotal connections.

63. An amphibian for use in land and marine modes comprising:
a planing hull;
three wheel stations, two of the three wheel stations being front wheel stations provided one on each side of and in the front half of the amphibian, and the third wheel station being a rear wheel station provided in the rear half of the amphibian;
at least one wheel provided at each wheel station, each wheel being movable between a protracted land mode position and a retracted marine mode position;
a retractable suspension assembly provided at each wheel station for supporting the at least one wheel, the front wheel station retractable suspension assemblies each being configured to provide capability for leaning of the amphibian when in use in land mode;
land propulsion means to propel the amphibian on land in the land mode, the land propulsion means comprising at least one of the wheels; and
marine propulsion means to propel the amphibian on water in the marine mode.

64. An amphibian for use in land and marine modes comprising:
a planing hull;
three wheel stations, two of the three wheel stations being rear wheel stations provided one on each side of and in the rear half of the amphibian, and the third wheel station being a front wheel station provided in the front half of the amphibian;
at least one wheel provided at each wheel station, each wheel being movable between a protracted land mode position and a retracted marine mode position;
a retractable suspension assembly provided at each wheel station for supporting the at least one wheel, the rear wheel station retractable suspension assemblies each being configured to provide capability for leaning of the amphibian when in use in land mode;
land propulsion means to propel the amphibian on land in the land mode, the land propulsion means comprising at least one of the wheels; and
marine propulsion means to propel the amphibian on water in the marine mode.

65. An amphibian for use in land and marine modes comprising:
a planing hull;
four wheel stations, two of the four wheel stations being front wheel stations provided one on each side of and in the front half of the amphibian, and two of the four wheel stations being rear wheel station provided one on each side of and in the rear half of the amphibian in the front half of the amphibian;
at least one wheel provided at each wheel station, each wheel being movable between a protracted land mode position and a retracted marine mode position;
a retractable suspension assembly provided at each wheel station for supporting the at least one wheel, the wheel station retractable suspension assemblies each being configured to provide capability for leaning of the amphibian when in use in land mode;
land propulsion means to propel the amphibian on land in the land mode, the land propulsion means comprising at least one of the wheels; and
marine propulsion means to propel the amphibian on water in the marine mode.

66-67. (canceled)
